(19) United States
(12) Patent Application Publication
(10) Pub. No.: US 2012/0081298 A1
(43) Pub. Date: Apr. 5, 2012

(54) TOUCH SENSING PANELS AND OPERATION METHODS THEREOF

(75) Inventors: Martin John Edwards, Crawley (GB); John Richard Ayres, Surrey (GB)

(73) Assignee: CHIMEI INNOLUX CORPORATION, CHU-NAN (TW)

(21) Appl. No.: 12/896,695

(22) Filed: Oct. 1, 2010

(51) Int. Cl. G06F 3/041

(52) U.S. Cl. 345/173

(57) ABSTRACT

A touch sensing panel includes a substrate and a plurality of first sub-electrodes. The first sub-electrodes are formed on the substrate and disposed in parallel. The first sub-electrodes extend in a first direction. Each set of the successive first sub-electrodes is grouped as a group into a predetermined number to form one sensing electrode. A distance between two successive sensing electrodes is less than the predetermined number multiplied by a distance between two successive first sub-electrodes.

### BACKGROUND OF THE INVENTION

1. Field of the Invention

The invention relates to a touch sensing panel, and more particularly to a touch sensing panel with a novel sensing electrode structure.

2. Description of the Related Art

FIG. 1 shows a conventional touch sensing panel. Referring to FIG. 1, a plurality of vertical sub-electrodes 10 and a plurality of horizontal sub-electrodes 11 are formed on a substrate. In FIG. 1, eighteen vertical sub-electrodes 10₁˜10₁₈ and four horizontal sub-electrodes 11₁˜11₄ are given as an example. A sensing electrode is formed by grouping the vertical sub-electrodes of a predetermined number M. The distance between any two successive vertical sub-electrodes is represented by D_sub. As shown in FIG. 1, three vertical sub-electrodes (M=3) are grouped to form a sensing electrode, and no two successive sensing electrodes overlap. For example, the vertical sub-electrodes 10₁˜10₃ are grouped to form a sensing electrode 12₁, and the vertical sub-electrodes 10₄˜10₆ are grouped to form a sensing electrode 12₂. The sensing electrodes 12₃˜12₆ are formed in the same manner as previously stated; thus, related descriptions are omitted. The successive sensing electrodes 12₁ and 12₂ do not overlap, and the successive sensing electrodes 12₂ and 12₃ do not overlap. According to the structure of the sensing electrodes 12₁˜12₆, the distance between any two successive sensing electrodes is fixed. For example, the distance D10 between the sensing electrodes 12₁ and 12₂ is equal to three times the distance D_sub. That is, the distance D10 is equal to the predetermined number M multiplied by the distance D_sub (M*D_sub).

FIGS. 2a˜2e show the relationship between the real position (RP) of an object contacting the touch sensing panel 1 and the amplitude (A) of output signals of the sensing electrodes 12₁˜12₅. The five output signals are combined to derive the position of the object by a particular calculation. In FIG. 2c, “X” represents the center of the sensing electrode 12₃. FIG. 2f shows the relationship between the real position of the object and the derived position of the object generated from the output signals of the sensing electrodes 12₁˜12₅, wherein the relationship is represented by a curve 20. As shown in FIG. 2f, the curve 20 has an approximately linear behavior as shown by a line 21 according to points P20˜P26 of the curve 20, wherein the points P20˜P26 occur when the object is located directly on the center of each sensing electrodes 12₁˜12₅ and when the object is located on the midway point between the centers of two successive sensing electrodes. However, when the object is located at an intermediate position, for example a position indicated by “E”, there is an error between the curve 20 and the line 21. The error results in difficulty in accurately determining the position of the object.

### BRIEF SUMMARY OF THE INVENTION

An exemplary embodiment of a touch sensing panel is provided. The touch sensing panel comprises a substrate and a plurality of first sub-electrodes. The first sub-electrodes are formed on the substrate and disposed in parallel. The first sub-electrodes extend in a first direction. Each set of the successive first sub-electrodes is grouped as a group into a predetermined number to form one sensing electrode. A distance between two successive sensing electrodes is less than the predetermined number multiplied by a distance between two successive first sub-electrodes.

In some embodiments, when the touch sensing panel operates in a high resolution, the distance between two successive sensing electrodes is set to equal to the distance between two successive first sub-electrodes. When the touch sensing panel operates in a low resolution, the distance between two successive sensing electrodes is set to equal to a number, which is equal to the predetermined number minus one, multiplied by the distance between two successive first sub-electrodes.

An exemplary embodiment of an operation method of a touch sensing panel is provided. The operation method comprises the steps of: providing a substrate; providing a plurality of first sub-electrodes on the substrate, wherein the plurality of first sub-electrodes are disposed in parallel and extend in a first direction; and grouping each set of the successive first sub-electrodes into a predetermined number as a group to form one sensing electrode. A distance between two successive sensing electrodes is less than the predetermined number multiplied by a distance between two successive first sub-electrodes.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional touch sensing panel;

FIGS. 2a˜2e show the relationship between the real position of an object contacting the touch sensing panel of FIG. 1 and the amplitude of output signals of the sensing electrodes of FIG. 1;

FIG. 2f shows the relationship between the real position of the object and the derived position of the object generated from the output signals of the sensing electrodes of FIG. 1;

FIG. 3 shows an exemplary embodiment of a touch sensing panel;

FIGS. 4a˜4e show the relationship between the real position of an object contacting the touch sensing panel of FIG. 3 and the amplitude of output signals of the sensing electrodes of FIG. 3;

FIG. 4f shows the relationship between the real position of the object and the derived position of the object generated from the output signals of the sensing electrodes of FIG. 3;

FIG. 5 shows another exemplary embodiment of a touch sensing panel;

FIG. 6 is a flow chart of an exemplary embodiment of an operation method of a touch sensing panel;

FIG. 7 shows an exemplary embodiment of a display device; and

FIG. 8 shows an exemplary embodiment of an electronic device.

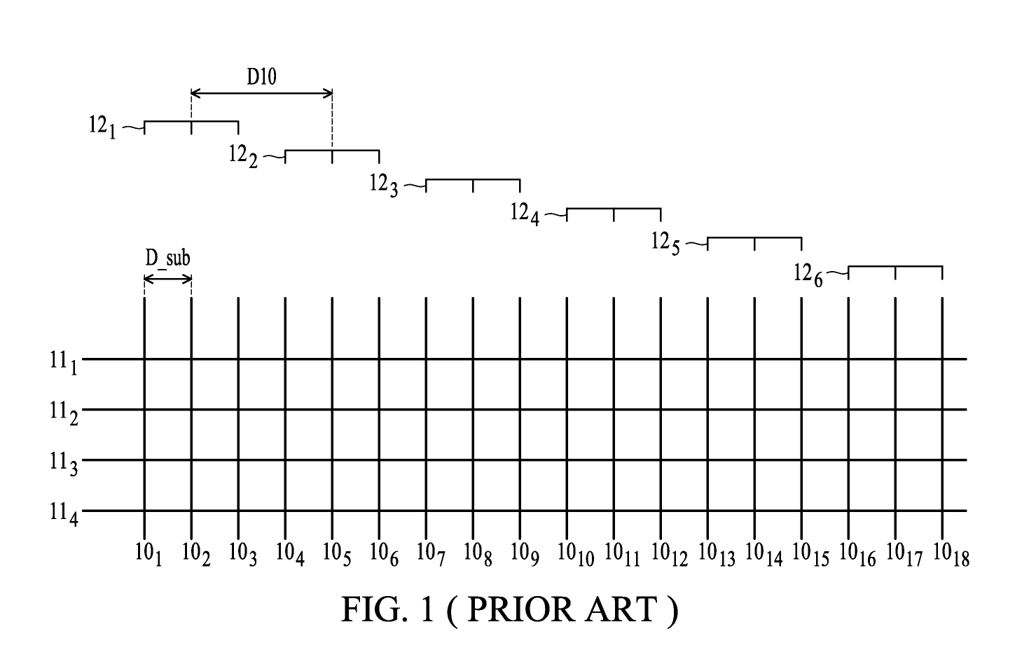

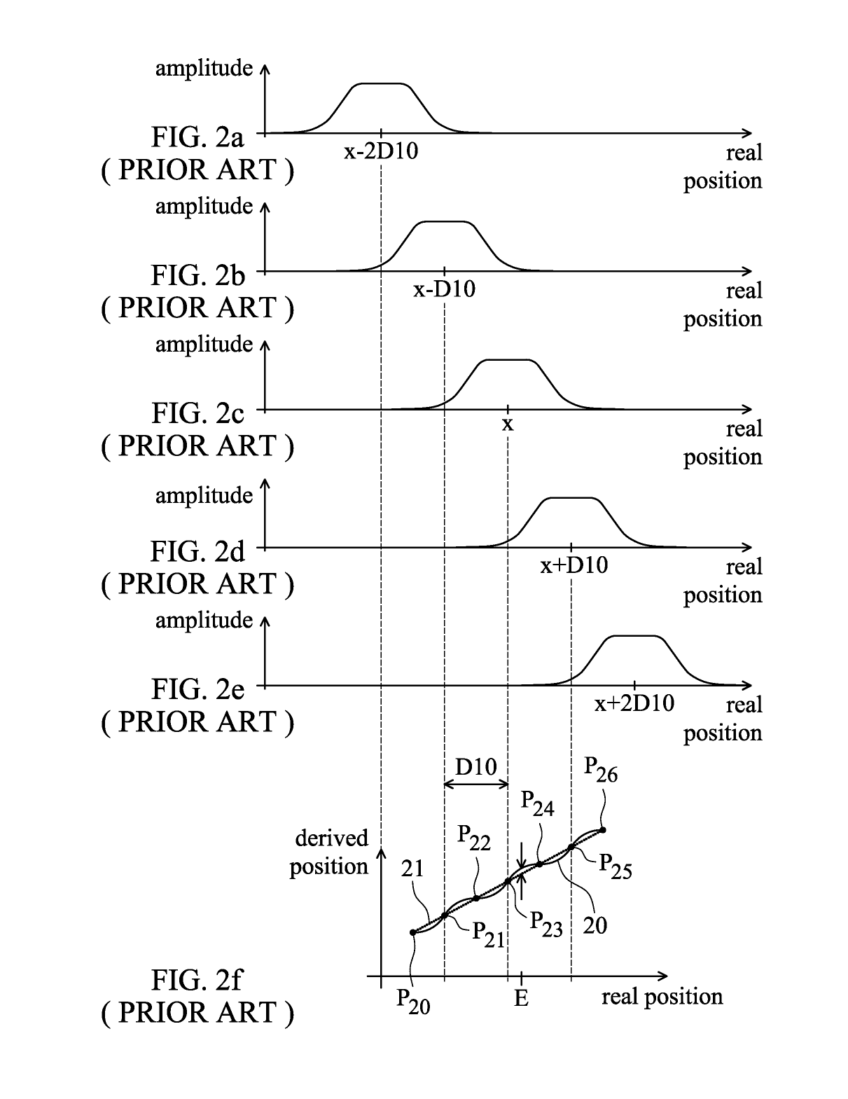

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

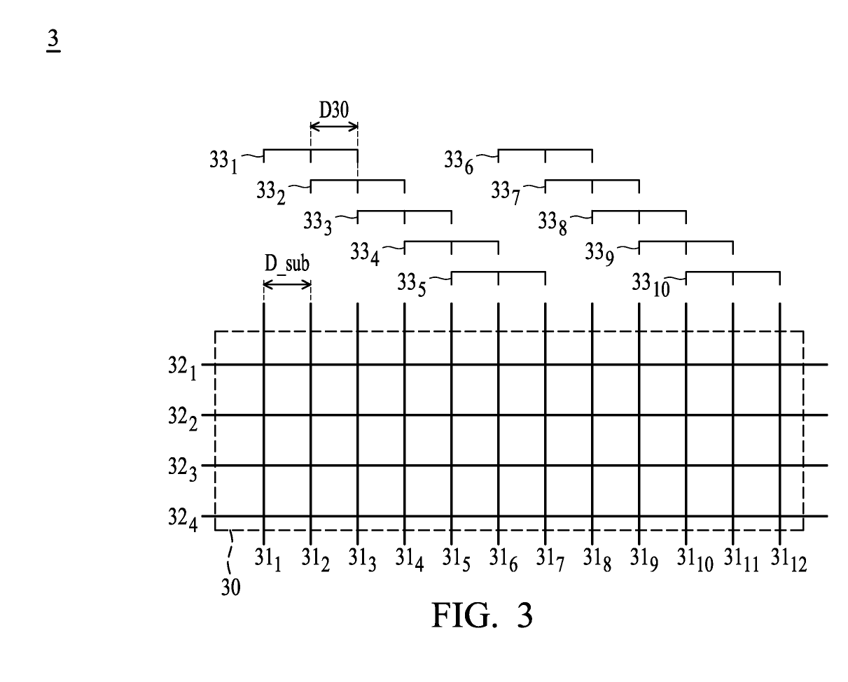

Touch sensing panels are provided. In an exemplary embodiment of a touch sensing panel in FIG. 3, a touch sensing panel 3 performs a sensing operation and comprises a substrate 30, a plurality of sub-electrodes 31, and a plurality of sub-electrodes 32. In the embodiment of FIG. 3, twelve sub-electrodes 31₁˜31₁₂ and four sub-electrodes 32₁˜32₄ are given as an example. The sub-electrodes 31₁˜31₁₂ and the sub-electrodes 32₁˜32₄ are formed on the substrate 30. The sub-electrodes 31₁˜31₁₂ are disposed in parallel and extend in a vertical direction. The sub-electrodes 32₁˜32₄ are disposed in parallel and extend in a horizontal direction intersecting the vertical direction. Each set of the successive sub-electrodes 31 is grouped into a predetermined number N to form one sensing electrode. In the embodiment, the predetermined number N is equal to 3 (N=3) for example. Thus, each set of three successive sub-electrodes 31 is grouped to form one sensing electrode. For example, the group of the sub-electrodes 31₁˜31₃ forms a sensing electrode 33₁, and the group of the sub-electrodes 31₂˜31₄ forms a sensing electrode 33₂. Sensing electrodes 33₃˜33₁₀ are formed by the same structure as the sensing electrodes 33₁ and 33₂; thus, related descriptions are omitted. Referring to FIG. 3, the distance between any two successive sub-electrodes 31 is represented by D_sub, and the distance between any two successive sensing electrodes 33 is represented by D30. The distance D30 between any two successive sensing electrodes 33 is less than the predetermined number N (that is 3) multiplied by the distance D_sub between two successive sub-electrodes 31 referred to as the distance D30_upper, that is 3*D_sub=D30_upper, and D30<D30_upper. In the embodiment of FIG. 3, the distance D30 is equal to one time the distance D_sub (D30=D_sub). Thus, two successive sensing electrodes 33 (that is, two corresponding successive groups of the sub-electrodes 31) overlap.

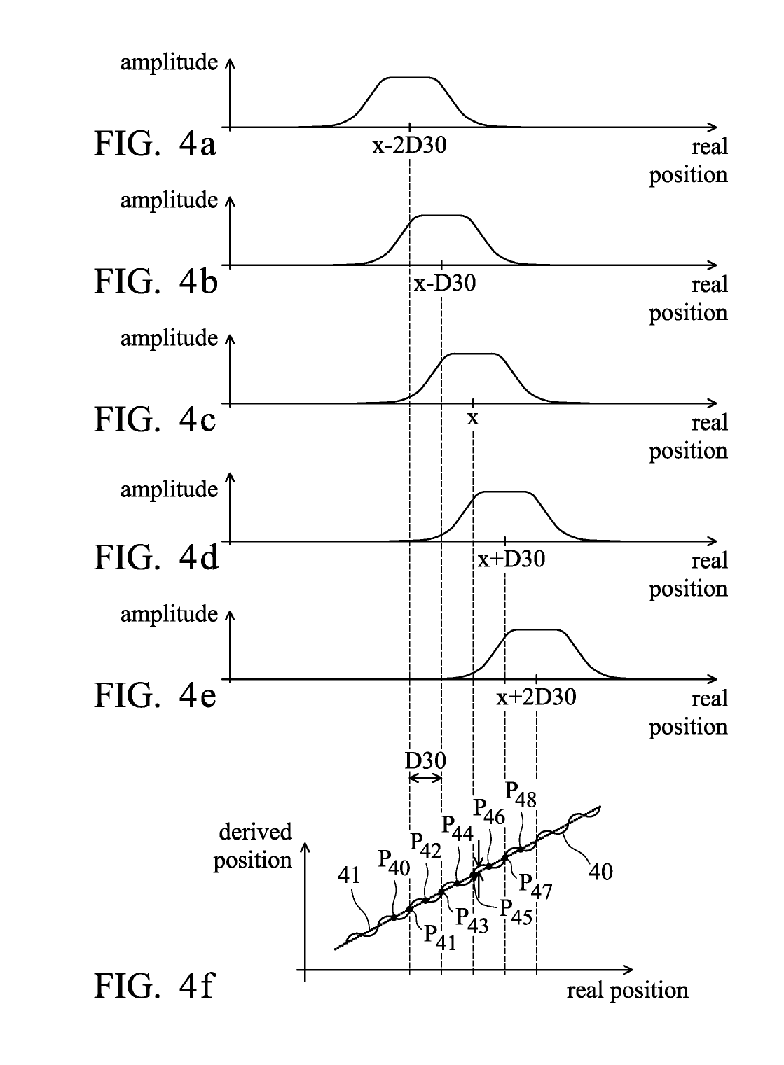

FIGS. 4a˜4e show the relationship between the real position of an object contacting the touch sensing panel 3 and the amplitude of output signals of the sensing electrodes 33₁˜33₅. The five output signals are combined to derive the position of the object by a particular calculation. In FIG. 4c, “X” represents the center of the sensing electrode 33₃. FIG. 4f shows the relationship between the real position of the object and the derived position of the object generated from the output signals of the sensing electrodes 33₁˜33₅, wherein the relationship is represented by a curve 40. As shown in FIG. 4f, the curve 40 has an approximately linear behavior as shown by a line 41 according to points P40˜P48 of the curve 40, wherein the points P40˜P48 occur when the object is located directly on the center of each sensing electrode 33₁˜33₅ and when the object is located on the midway point between the centers of two successive sensing electrodes. In the embodiment of FIG. 3, compared with the touch sensing panel 1, since the distance D30 between any two successive sensing electrodes 33 is reduced to one time the distance D_sub (D30=D_sub), each range in which an intermediate position may appear is narrow. Thus, the disadvantageous effect resulting from errors in the intermediate position is lessened.

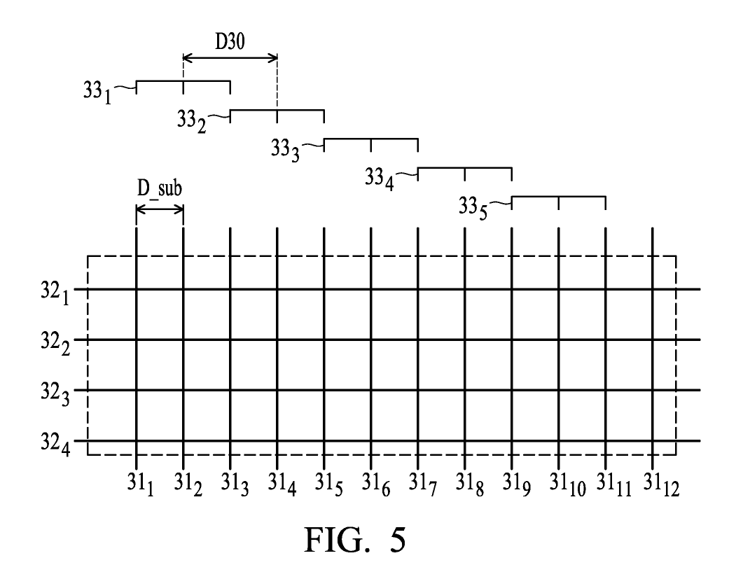

In some embodiments, the distance D30 between two successive sensing electrodes 33 can be dynamically varied. For example, the distance D30 is varied with the resolution of the touch sensing panel 3. Note that the distance D30 is still less than the distance D30_upper. If the touch sensing panel 3 is switched to perform the sensing operation with a high resolution, the distance D30 is set to be equal to the distance D_sub (D30=D_sub) as shown in FIG. 3. If the touch sensing panel 3 is switched to perform the sensing operation with a low resolution, the distance D30 is set to be equal to two times the distance D_sub (D30=(3−1)*D_sub), as shown in FIG. 5), thereby reducing power consumption or scanning frequency of the sensing electrodes. Referring to FIG. 5, two successive sensing electrodes 33 (that is, two corresponding successive groups of the sub-electrodes 31) overlap. For example, in FIG. 5, the successive sensing electrodes 33₁ and 33₂ overlap due to the common sub-electrodes 31₃.

In some other embodiments, the touch sensing panel 3 has different distances between two successive sensing electrodes. Specifically, the touch sensing panel 3 is divided into a plurality of areas, and the distances between two successive sensing electrodes 33 in one area is different from the distances between any two successive sensing electrodes 33 in another area. The different distances allow the resolution of the touch sensing electrode 3 to vary over the areas, for example, the resolution of the area where a known object will contact with is increased. The different distances also allow variation of the resolution of the areas according to the size of known objects contacting the areas.

In the embodiments of FIGS. 3 and 5, the formation of the vertical sensing electrodes 33₁˜33ₘ is described by taking the vertical sub-electrodes 31₁˜31₁₂, and the position of the object on the horizontal direction is detected through the vertical sensing electrodes 33₁˜33₁₀. However, in some embodiments, the position of the object on the vertical direction is also required to be detected. One skilled in the art can logically use the above formation of the sensing electrodes 33₁˜33₁₀ to form horizontal sensing electrodes by grouping the horizontal sub-electrode 32₁˜32₄. Thus, the description related to the horizontal sensing electrodes formed in the same formation is omitted here.

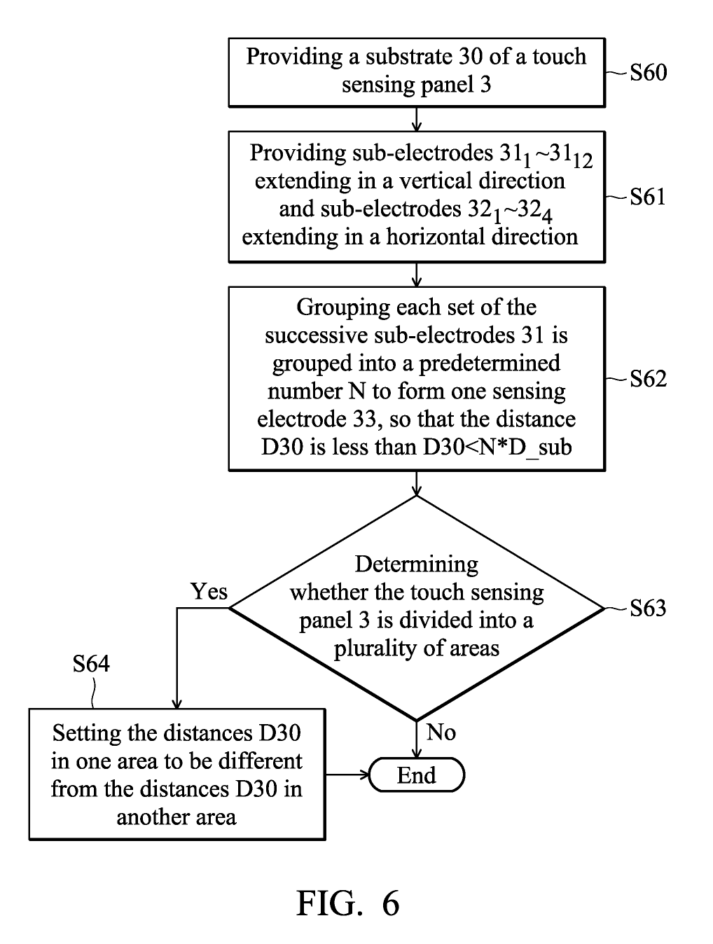

FIG. 6 is a flow chart of an exemplary embodiment of an operation method of a touch sensing panel. In the following, the operation method will be described according to FIGS. 3-4 and 6. Referring to FIG. 6, first, a substrate 30 is provided (step S60). Sub-electrodes 31₁˜31₁₂ and sub-electrodes 32₁˜32₄ are provided on the substrate 30 (step S61). The sub-electrodes 31₁˜31₁₂ are disposed in parallel and extend in a vertical direction. The sub-electrodes 32₁˜32₄ are disposed in parallel and extend in a horizontal direction intersecting the vertical direction.

Then, each set of the successive sub-electrodes 31 is grouped into a predetermined number N to form one sensing electrode 33 (step S62), so that the distance D30 between two successive sensing electrodes 33 is less than the predetermined number multiplied by a distance D_sub between two successive sub-electrodes 31 (D30<N*D_sub). In some embodiments, if the touch sensing panel 3 is switched to perform the sensing operation with a high resolution, the distance D30 is set to be equal to the distance D_sub the distance between any two successive sub-electrodes 31 (D30=D_sub), as shown in FIG. 3. If the touch sensing panel 3 is switched to perform the sensing operation with a low resolution, the distance D30 is set to be equal to two times the distance D_sub (D30=(3−1)*D_sub), as shown in FIG. 5), thereby reducing power consumption or scanning frequency of the sensing electrodes.

Then, it is determined whether the touch sensing panel 3 is divided into a plurality of areas (step S63). If the touch sensing panel 3 is not divided into a plurality of areas, the method ends. If the touch sensing panel 3 is divided into plurality of areas, the distances D30 between two successive sensing electrodes 33 in one area is set to be different from the distances D30 between any two successive sensing electrodes 33 in another area (step S64).

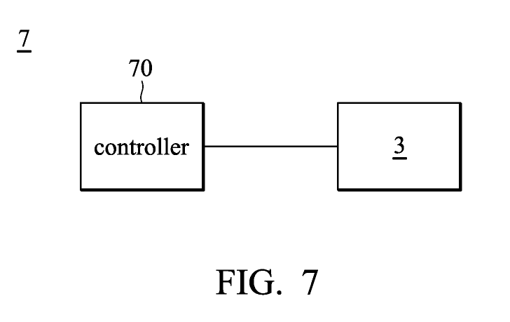

FIG. 7 schematically shows a display device 7 employing the disclosed touch sensing panel 3. Generally, the display device 7 includes a controller 70 and the touch sensing panel 3 shown in FIG. 3, etc. The controller 70 is operatively coupled to the touch sensing panel 3 and provides control signals to the touch sensing panel 3.

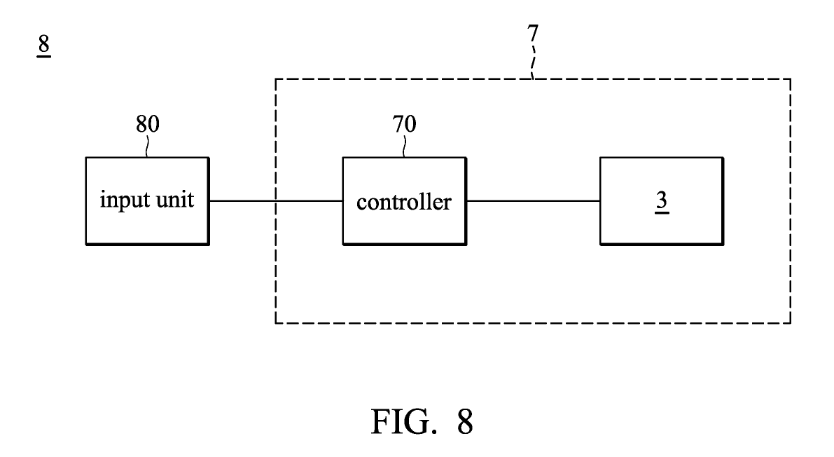

FIG. 8 schematically shows an electronic device 8 employing the disclosed display device 7. The electronic device 8 may be a portable device such as a PDA, digital camera, notebook computer, tablet computer, cellular phone, a display monitor device, or similar. Generally, the electronic device 8 comprises an input unit 80 and the display device 7 shown in FIG. 7, etc. Further, the input unit 80 is operatively coupled to the display device 7 and provides input signals to the display device 7. The controller 70 of the display device 7 provides the control signals to the touch sensing panel 3 according to the input signals.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch sensing panel comprising:
a substrate;
a plurality of first sub-electrodes formed on the substrate, disposed in parallel and extending in a first direction,
wherein each set of the successive first sub-electrodes is grouped as a group into a predetermined number to form one sensing electrode, and
wherein a distance between two successive sensing electrodes is less than the predetermined number multiplied by a distance between two successive first sub-electrodes.

2. The touch sensing panel as claimed in claim 1, wherein two successive groups of the first sub-electrodes overlap.

3. The touch sensing panel as claimed in claim 1, wherein the distance between two successive sensing electrodes is equal to the distance between two successive first sub-electrodes.

4. The touch sensing panel as claimed in claim 3, wherein the touch sensing panel operates in a high resolution.

5. The touch sensing panel as claimed in claim 1, wherein the distance between two successive sensing electrodes is equal to a number, which is equal to the predetermined number minus one, multiplied by the distance between two successive first sub-electrodes.

6. The touch sensing panel as claimed in claim 5, wherein the touch sensing panel operates in a low resolution.

7. The touch sensing panel as claimed in claim 1, wherein the touch sensing panel is divided into a plurality of areas, and the distance between two successive distance between two successive sensing electrodes in another area among of the plurality of areas.

8. The touch sensing panel as claimed in claim 1 further comprising:
a plurality of second sub-electrodes disposed in parallel and extending in a second direction intersecting the first direction.

9. A display device comprising:
a touch sensing panel as claimed in claim 1; and
a controller, wherein the controller is operatively coupled to the touch sensing panel.

10. An electronic device comprising:
a display device as claimed in claim 9; and
an input unit, wherein the input unit is operatively coupled to the display device.

11. The electronic device as claimed in claim 10, wherein the electronic device is a PDA, a digital camera, a display monitor, a notebook computer, a tablet computer, or a cellular phone.

12. An operation method of a touch sensing panel comprising:
providing a substrate;
providing a plurality of first sub-electrodes on the substrate, wherein the plurality of first sub-electrodes are disposed in parallel and extend in a first direction; and
grouping each set of the successive first sub-electrodes into a predetermined number as a group to form one sensing electrode, wherein a distance between two successive sensing electrodes is less than the predetermined number multiplied by a distance between two successive first sub-electrodes.

13. The operation method as claimed in claim 12 further comprising:
overlapping two successive groups of the first sub-electrodes.

14. The operation method as claimed in claim 12 further comprising:
setting the distance between two successive sensing electrodes to be equal to the distance between two successive first sub-electrodes when the touch sensing panel operates in a high resolution.

15. The operation method as claimed in claim 12 further comprising:
Setting the distance between two successive sensing electrodes to be equal to a number, which is equal to the predetermined number minus one, multiplied by the distance between two successive first sub-electrodes when the touch sensing panel operates in a low resolution.

16. The operation method as claimed in claim 12 further comprising:
determining whether the touch sensing panel is divided into a first area and a second area;
if the touch sensing panel is divided into the first area and the second area, setting the distance between two successive sensing electrodes in the first area to be different from the distance between two successive sensing electrodes in the second area.

17. The operation method as claimed in claim 12 further comprising:
providing a plurality of second sub-electrodes on the substrate, wherein the plurality of second sub-electrodes is disposed in parallel and extend in a second direction intersecting the first direction.
